(19) United States
(12) Patent Application Publication
(10) Pub. No.: US 2009/0024582 A1
(43) Pub. Date: Jan. 22, 2009

(54) METHODS AND SYSTEMS FOR SELECTIVELY PROVIDING DEFAULT VALUES TO DATABASE REQUESTS

(75) Inventors: Bason Chung, Montreal (CA); Bernhard Meier, St-Lazare (CA); Mary Patone, Montreal (CA); Donald Bricault, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/839,437

(22) Filed: Aug. 15, 2007

Related U.S. Application Data
(60) Provisional application No. 60/950,289, filed on Jul. 17, 2007.

(51) Int. Cl. G06F 17/30

(52) U.S. Cl. 707/3; 707/E17.008

(57) ABSTRACT

Methods and systems for handling database requests are provided. Default values for one or more database fields are stored in a default value file. A software entity can use the default values to complete a requested set of data when, for example, the data returned from the database is incomplete.

### RELATED APPLICATION

This application is related to, and claims priority from, U.S. Provisional Patent Application Ser. No. 60/950,289, entitled “Methods and Systems for Selectively Providing Default Values to Database Requests”, filed on Jul. 17, 2007, the disclosure of which is incorporated here by reference.

### TECHNICAL FIELD

The present invention generally relates to database methods and systems and, more particularly, to methods and systems for selectively providing default values in response to database requests, e.g., requests associated with messaging systems.

### BACKGROUND

Communication devices and systems in general, and messaging systems in particular, continue to gain in popularity. Paging, instant messaging (IM), text messaging on cell phones (e.g., Short Message Service (SMS)) and multimedia messaging (MMS) are examples of messaging systems which have enjoyed popularity over the years. SMS, for example, has been a successful feature of the Global System for Mobile Communications (“GSM”) second generation systems (“2G”). The success of SMS has been due, in part, to its ubiquitous nature—all GSM-capable devices support SMS functionality so there is no need to check each device to determine whether or not it supports SMS applications.

With the popularity of the Internet and the increased capability of personal computers, multimedia technology continues to rapidly develop to allow new capabilities, such as multimedia messages, games, presentations and services that are now considered by many to be a part of everyday life. Thus, the SMS service for text messaging between GSM users has been succeeded by a multimedia message service (“MMS”). MMS provides multimedia messaging capability, e.g., the capability to transfer messages including one or more media elements, such as text, voice, image and video, which elements can then be presented to a recipient of the multimedia message in an ordered manner.

An exemplary multimedia messaging center (MMC), which is an entity responsible for the storage and handling of incoming and outgoing multimedia messages and for the transfer of messages between different messaging systems, is illustrated in FIG. 1. Therein, the MMC 100 includes a multimedia service relay/server 102 connected to a message storage unit 106 and a database 108. The message storage unit 106 can be used, for example, to store messages for later delivery by the MMC 100. The database 108, which is also sometimes referred to as customer, subscriber or operator directory, contains service and subscriber profile data which is used in the processing of MMS messages.

When the MMC 100 receives an MMS message for processing, it will attempt to retrieve relevant service/subscriber profile information from the database 108. For example, suppose that the MMC 100 receives an MMS message from one of a number of various networks 110, e.g., 2 G networks, 3 G networks, IP networks, etc. To process this message, the MMC 100 obtains, for example, subscriber preference information, e.g., as illustrated in the flowchart of FIG. 2, from the database 108. Therein, at step 200, the MMC 100 receives the MMS message and initiates a search for subscriber preferences, e.g., by querying the database 108 with a subscriber ID. The subscriber's preference information is located at step 202 and returned to the MMS Relay/Server 102 at step 204. Such information can include, for example, attributes associated with the manner in which a particular subscriber has indicated that he or she wants MMS messages addressed to him or her to be processed, e.g., specification of a forwarding email address.

Unfortunately, there are a number of circumstances which may arise that render it difficult or impossible to process messages on behalf of subscribers. For example, the requested subscriber attributes may not be available from the database(s) 108. This could occur due to, for example, (1) improper provisioning of the attributes in the database 108 by a provisioning system, (2) a mismatch between expected schemas associated with the data and the available schema, (3) a mismatch between old and new schemas during an upgrade or data migration period, or (4) a deliberate under-provisioning of the database 108 to conserve system resources. Another failure category for MMS message processing as described above can occur when the directory or database is completely unreachable. This could, for example, occur as the result of a network error or a remote system failure/restart.

### SUMMARY

Accordingly, it would be desirable to provide devices, systems and methods which overcome the afore-described deficiencies to facilitate database operations associated with, for example, message processing.

According to an exemplary embodiment, a method for processing messages in a communications system includes receiving a message, querying at least one database to obtain data associated with preference attributes for handling the message, receiving an incomplete set of preference attribute data from the at least one database, completing said set of preference attribute data using default values, and processing the message using the completed set of preference attribute data.

According to another exemplary embodiment, a method for processing messages in a communications system includes receiving a message, determining whether to obtain subscriber preference information associated with the message from at least one database or from a default values file, selectively either obtaining the subscriber preference information from the default values file, otherwise, obtaining the subscriber preference information from the at least one database, and processing the message using the subscriber preference information.

According to still another exemplary embodiment, a method for handling a database request includes the step of: filling at least a portion of the database request using default values.

According to still another exemplary embodiment, a multimedia messaging center includes at least one database for storing subscriber preference attribute data associated with handling of multimedia messages, a multimedia server for receiving a multimedia message and for sending a request for subscriber preference data associated with the multimedia message toward the at least one database; and a plug-in software entity for receiving the request from the multimedia server and selectively providing subscriber preference data in response thereto from at least one of the database and a default values file.

According to another exemplary embodiment, a computer-readable medium contains instructions which, when executed on a computer, perform the steps of querying at least one database to obtain data associated with preference attributes for handling the message, receiving an incomplete set of preference attribute data from the at least one database, and completing the set of preference attribute data using default values.

According to still another exemplary embodiment, a node for processing messages includes a memory device for storing a default values file, and a processor for receiving a message and for sending a database query to obtain data for handling the message and for receiving an incomplete set of data in response to the database query, wherein the processor completes the data for handling the message by retrieving data from the default values file to fill in data which is missing in the incomplete set of data and processes the message using the completed set of data.

### BRIEF DESCRIPTION OF THE DRAWINGS

The accompanying drawings, which are incorporated in and constitute a part of the specification, illustrate one or more exemplary embodiments and, together with the description, explain these exemplary embodiments. In the drawings:

FIG. 1 illustrates a portion of a conventional messaging system;

FIG. 2 illustrates a conventional method of processing a message in the system of FIG. 1;

FIG. 3 illustrates a portion of a messaging system according to an exemplary embodiment;

FIGS. 4(a)-4(d) depict a default values file according to an exemplary embodiment;

FIGS. 5 is a flowchart illustrating a method according to an exemplary embodiment;

FIG. 6 illustrates a communication node according to an exemplary embodiment;

FIG. 7 is a flowchart illustrating a method according to another exemplary embodiment; and

FIGS. 8, 9(a) and 9(b) are flowcharts illustrating methods according to other exemplary embodiments.

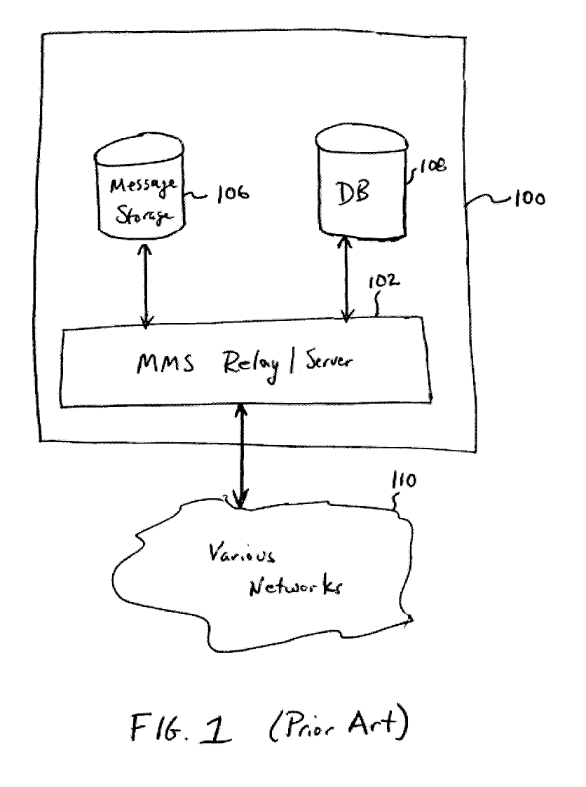

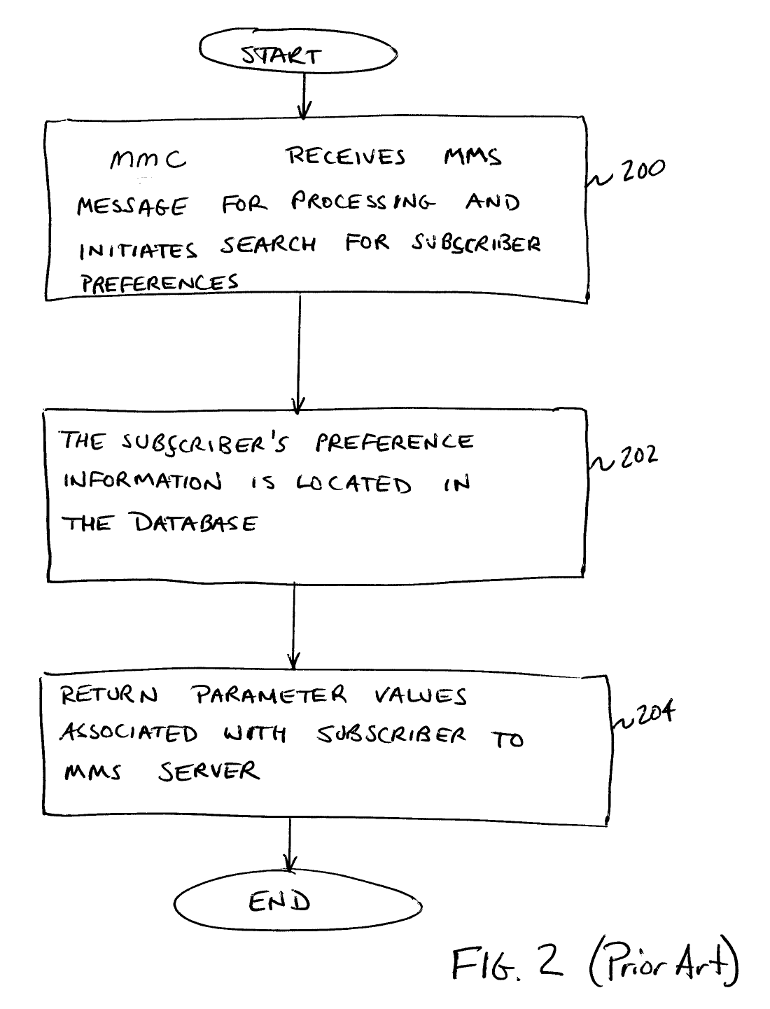

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

These exemplary embodiments describe a flexible architecture that supports present and future multimedia messaging technologies and can handle various message types and formats, such as fax, SMS, multimedia, voice-mail, IP Multimedia Subsystem (IMS) messaging and e-mail, albeit the examples provided herein are in terms of MMS messages. More specifically, these exemplary embodiments provide systems, methods and mechanisms for selectively providing default values in response to database requests, e.g., when a database returns an incomplete response to a request for subscriber information to be used in processing an MMS message. Note that, in this regard, the term “incomplete” as it is used herein refers to the point of view of the requester of the data rather than the point of view of the database since, for example, the database may intentionally not be provisioned with certain data that would be responsive to a request, as will be explained in more detail below. Additionally, as described below, these exemplary embodiments can be deployed to facilitate any database requests, e.g., in systems other than messaging systems.

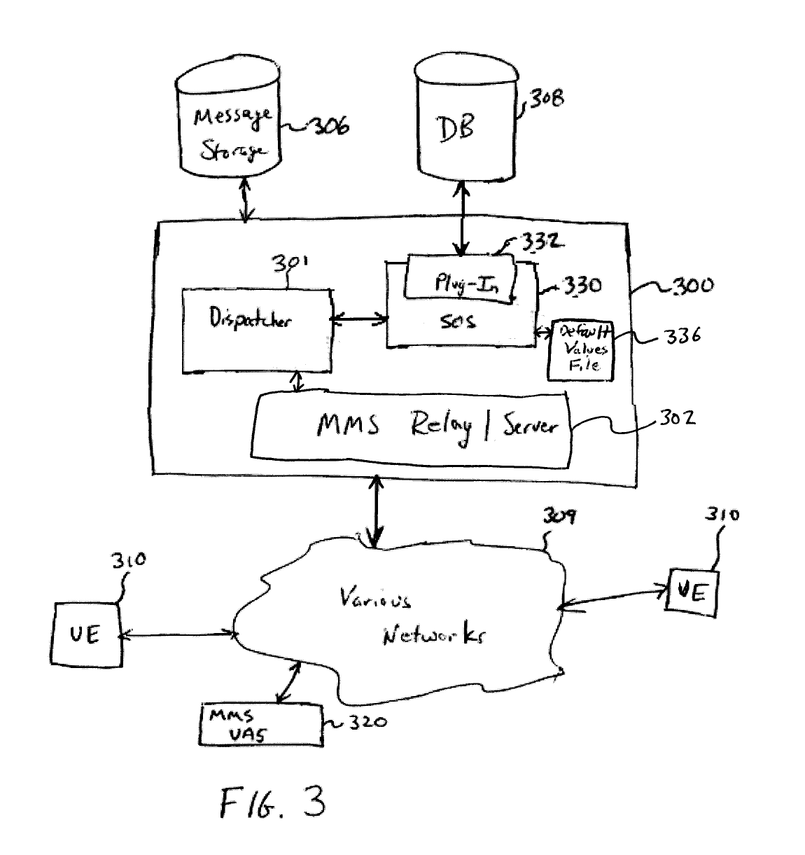

To provide some additional context for this discussion, an architectural overview of an MMC 300 in accordance with one exemplary embodiment is provided as FIG. 3. Therein, the MMC 300 may interact with a messaging environment which is generally represented by the various networks 309, but which is not limited to networks per se. For example, such a messaging environment 309 may include, as a non-exhaustive example, fixed networks, mobile networks (such as 2 G mobile networks, 3 G mobile networks, Long Term Evolution (LTE) networks, etc.), Internet/IP networks and/or a Value Added Service Provider (VASP) gateway. User equipment 310 or, more generally, devices which operate as MMS user agents (UAS) 320 are connected to the messaging environment 309 and are the originators and recipients of MMS messages. Each MMS user agent 320 is an application layer function that provides the users with the ability to view, compose and handle multimedia messages (e.g., submitting, receiving, deleting of multimedia messages).

The MMC 300 includes an MMS relay/server 302, a dispatcher 301, a subscribers, operators and services (SOS) subsystem 330 and one or more plug-in(s) 332 which connect to a message storage device 306 and one or more databases 308. The dispatcher 301 operates to, among other things, coordinate message retrieval from the message storage 306 for forwarding by the MMC 300. The SOS 330 provides for the population of empty fields/attributes with default content and the plug-in(s) 332 provide a mapping of data schemas from an external database to naming conventions which are used internally within the MMC 300, both of which are described in more detail below. The one or more databases 308, which may also be referred to as customer, subscriber and/or operator directories, contain various information associated with subscriber profiles to be used in processing messages as described herein. As a purely illustrative example, the one or more databases 308 can be directories which operate in accordance with the Lightweight Directory Access Protocol (LDAP). The MMC 300 is responsible for storage and/or handling of incoming and outgoing messages and for the transfer of messages between different messaging systems.

More specifically, the MMC 300 may perform one or more of the following MMS functions including, for example, receiving and sending multimedia messages, enabling/disabling MMS functions, personalizing MMS functionality based on user profile information, deleting multimedia messages based on user profile or filtering information, performing media type and format conversions, converting messages arriving at the MMC 300 from legacy messaging systems into a multimedia format (e.g., from facsimile to MMS), converting multimedia messages leaving the MMC toward legacy messaging systems into the appropriate message format (e.g., multimedia to Internet e-mail), retrieving message content, forwarding multimedia messages, screening multimedia messages, negotiating MMS UAS/UE terminal capabilities, checking MMS UAS/UE terminal availability, providing multimedia message notification, generating call data records, providing address translation, hiding addresses, managing the message properties on servers (e.g., voice-mail or e-mail servers) integrated into the messaging environment, providing temporary and/or persistent storage of messages, ensuring that messages are not lost until successfully delivered to another element, controlling the reply-charging feature of MMS, and other functions or services. The MMS server and MMS relay can be implemented as separate logical elements, or they can be combined into a single MMS relay/server element as shown in FIG. 3. Moreover, the MMS server and MMS relay functionality can be distributed across different domains. In yet another alternative configuration, if the message storage device 306 is implemented as network attached storage (NAS) instead of a database, the server functionality of block 302 can be omitted.

Among other things, the MMC 300 supports the ability to create, update, store, transfer, interrogate, manage and retrieve a user's multimedia messaging profiles. The multimedia messaging profiles allow a user to configure and personalize his or her multimedia messaging environment (e.g., which media types and notifications that will be delivered to the recipient, such as voice only or text only). This functionality is supported by data stored in the one or more databases 308. The one or more databases 308 include one or more entities or directories that contain user related information such as subscription and configuration information (e.g., user profile, subscription, operator services, Home Location Register (“HLR”), etc.) and provide customized message processing instructions. The one or more databases 308 can provide MMS user subscription information, information for the control of the extent of available service capability (e.g., server storage space), a set of rules relating to how to handle incoming messages and their delivery, and information of the current capabilities of the user's terminal.

According to exemplary embodiments, however, the data requests made to by the MMC 300 to the one or more databases 308 to obtain subscriber profile or preference information can involve processing by the SOS 330 and the plug-in(s) 332 in order to deliver final values of preference attributes to MMS relay/server 302, dispatcher 301 or another entity associated with MMC 300 for message handling. In order to deal with some of the data mismatch issues described above, the SOS 330 and the plug-in(s) 332 provide a mapping between a data schema (associated with the queried values) expected by the MMS relay/server 302 and the dispatcher 301 to a data schema which is actually available from the database(s) 308. For example, various versions of databases or directories 308 may have different syntaxes defined for variable or record names. Suppose that an older version of a database or directory 308 permits underscores in record names, but newer versions of the same database or directory 308 do not. Plug-in(s) 332 could therefore, as a purely illustrative example, provide a mapping for an attribute associated with a maximum size associated permitted for forwarding emails as follows:

To MMS Relay/Server 302 and Dispatcher 301 From Database 308

FWDTOEMAIL_MAXSIZE FWTOEMAILMAXSIZE

This mapping functionality enables, among other things, for newer databases or directories to be readily connected with legacy MMC's 300. Although only one plug-in 332 is shown in FIG. 3, it will be appreciated that a plurality of such software entities may be provided as need, e.g., one for each database or directory 308.

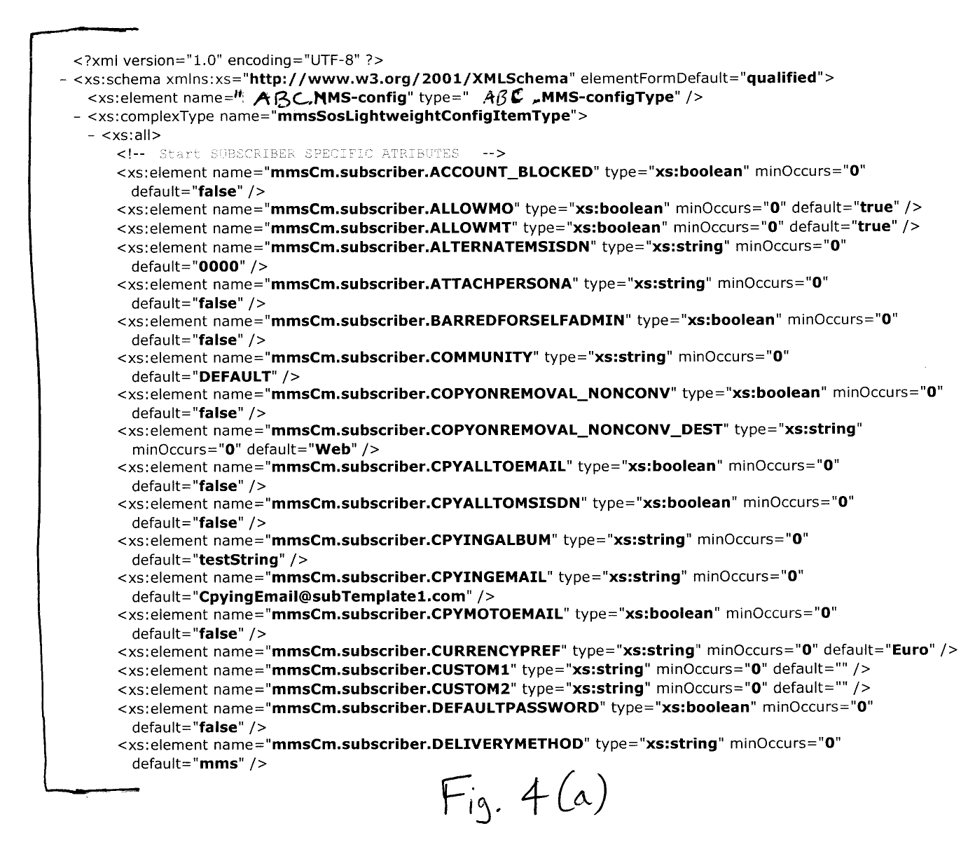

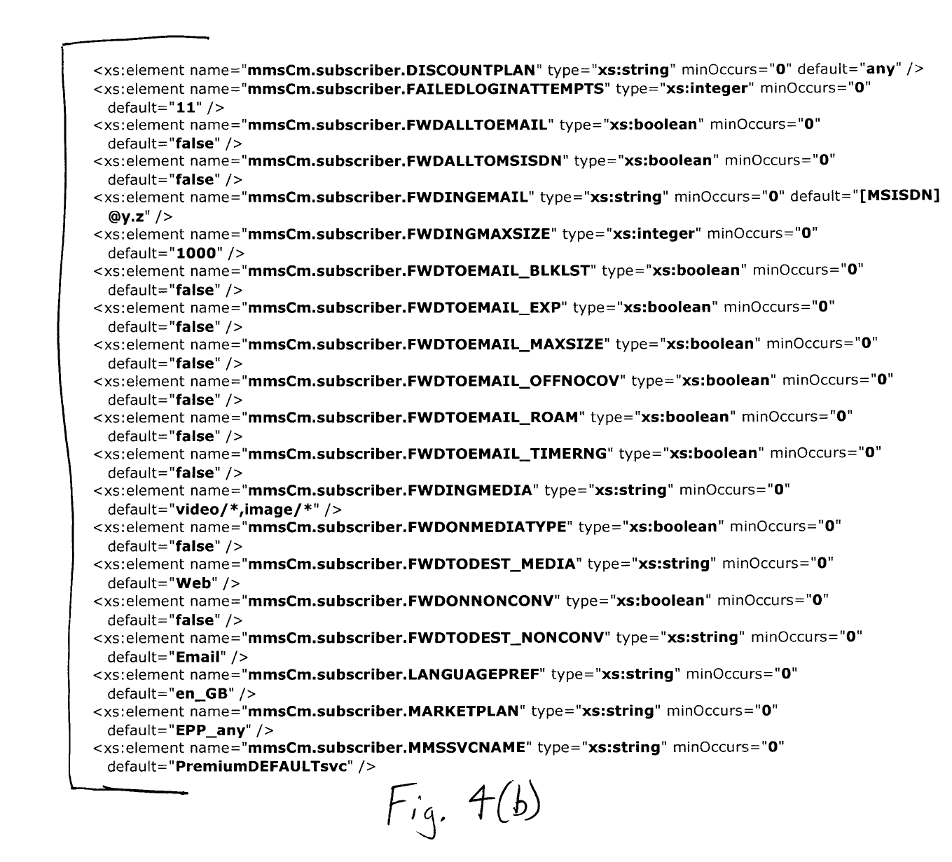

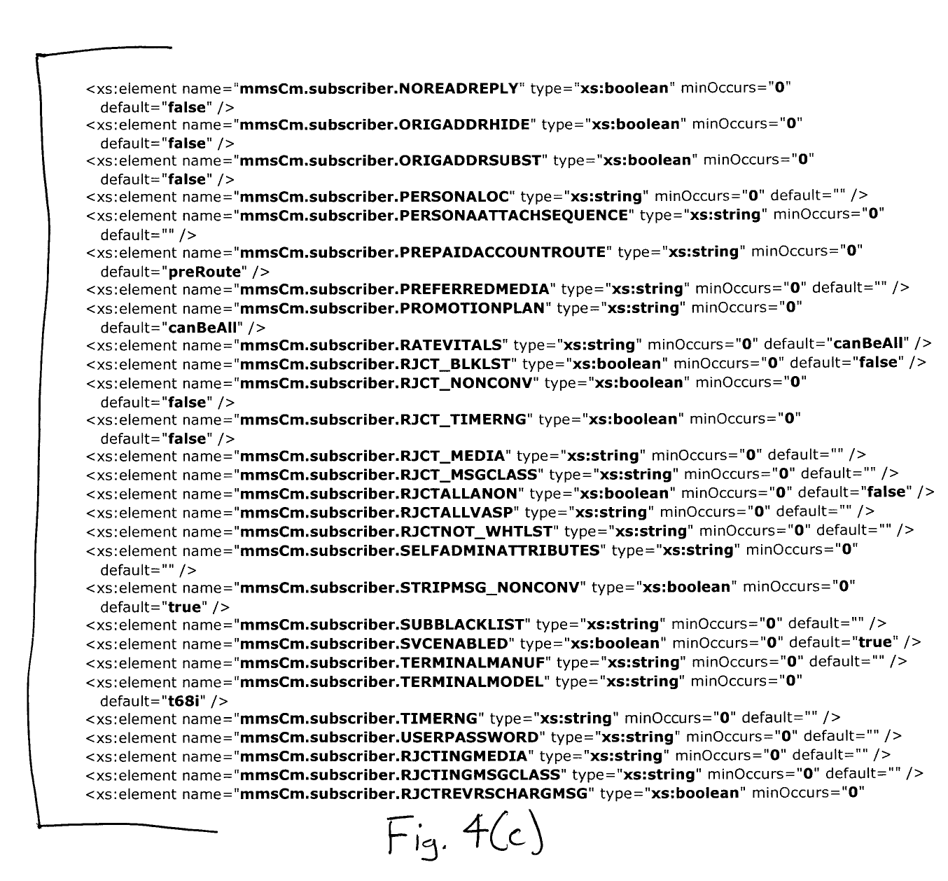

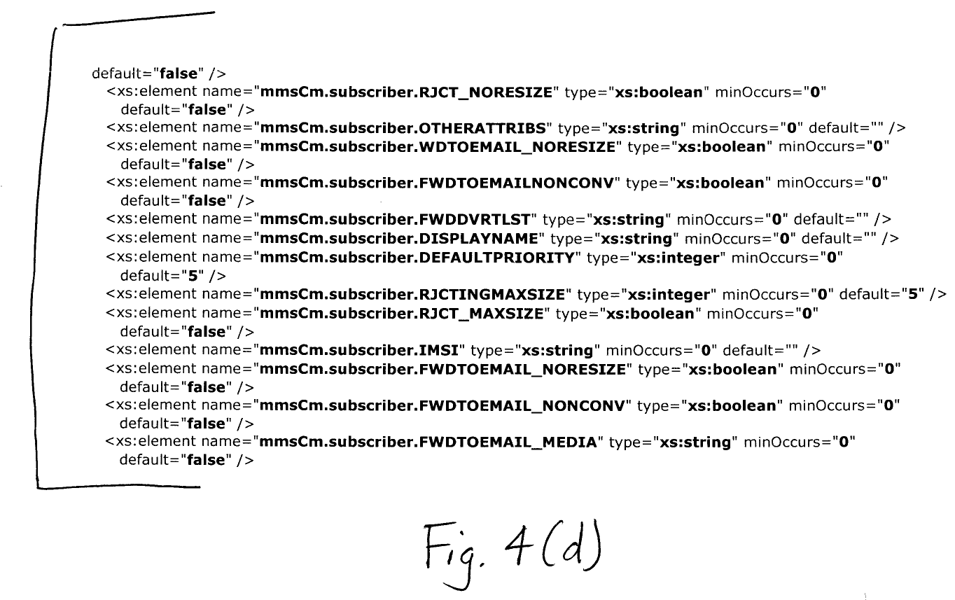

In addition to providing a mapping between an expected data schema and a data scheme available in the database or directory 308, the SOS 330 and plug-in(s) 332 provide functionality which can be used to address, e.g., incomplete data within the databases or directories 308. More specifically, SOS 330 can access a default values file 336 (an example of which is shown in FIGS. 4(a)-4(d)) which has stored therein a default value associated with one or more types of data elements which are stored in the databases or directories 308. For example, in the context of the aforedescribed MMS messaging system, the default values stored in a file, e.g., in a memory device associated with MMC 300, can correspond to default user preference attributes for handling MMS messages. A portion of such a default values file according to an exemplary embodiment is provided below.

```
<?xml version=“1.0” encoding=“UTF-8” ?>
- <xs:schema xmlns:xs=“http://www.w3.org/2001/XMLSchema”
elementFormDefault=“qualified”>
  <xs:element name=“ABC.MMS-config” type=“ABC.-
  MMS-configType” />
- <xs:complexType name=“mmsSosLightweightConfigItemType”>
- <xs:all>
- <!--
  Start SUBSCRIBER SPECIFIC ATTRIBUTES
  -->
  <xs:element name=“mmsCm.subscriber.ACCOUNT_BLOCKED”
type=“xs:boolean” minOccurs=“0” default=“false” />
  <xs:element name=“mmsCm.subscriber.ALLOWMO”
type=“xs:boolean”minOccurs=“0” default=“true” />
  <xs:element name=“mmsCm.subscriber.ALLOWMT”
type=“xs:boolean”minOccurs=“0” default=“true” />
  <xs:element name=“mmsCm.subscriber.ALTERNATEMSISDN”
type=“xs:string” minOccurs=“0” default=“0000” />
  <xs:element name=“mmsCm.subscriber.ATTACHPERSONA”
type=“xs:string” minOccurs=“0” default=“false” />
  <xs:element name=“mmsCm.subscriber.BARREDFORSELFADMIN”
type=“xs:boolean” minOccurs=“0” default=“false” />
  <xs:element name=“mmsCm.subscriber.COMMUNITY”
type=“xs:string”minOccurs=“0” default=“DEFAULT” />
```

A full version of this exemplary default values file is illustrated as FIGS. 4(a)-4(d). However it will be appreciated that this exemplary default values file is in all respects purely illustrative.

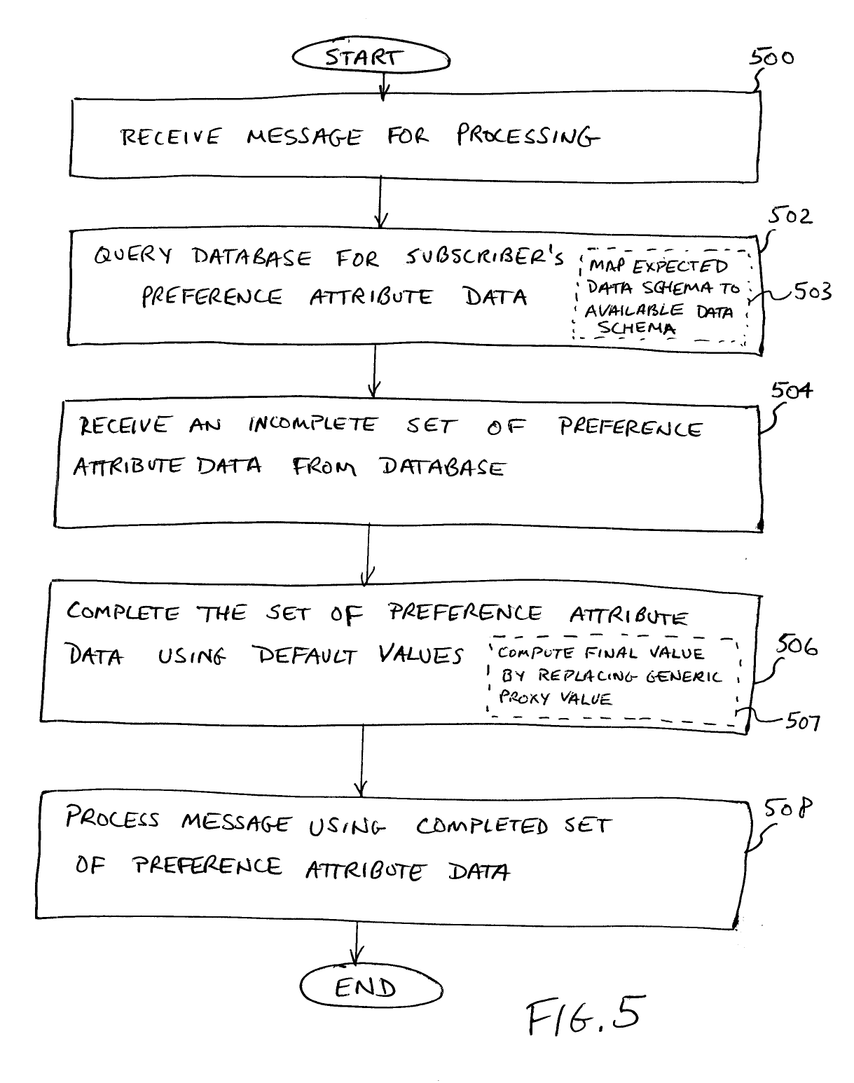

The default values file provides the SOS 330 according to these exemplary embodiments with the capability to provide improved message preference data to the MMC 300 relative to the data which may be available from the databases/directories 308 alone. For example, the default values provide a data source from which incomplete attribute sets returned from the databases/directories 308 can be filled. An example of one way in which this default values information can be used will now be described with reference to the flowchart of FIG. 5. Therein, at step 500, a message is received for processing. At least one database is queried at step 502 to, for example, obtain data associated with a subscriber's preference attributes for handling the received message. This step 502 can, optionally, include the step of mapping an expected data schema associated with the preference attributes to an available data schema associated with said preference attributes as shown by the dotted block 503.

In this example, the database(s) does not have all of the requested information, e.g., some of the preference attribute fields are empty. Thus, the database or directory 308 returns an incomplete set of preference attribute data which is received by the plug-in 332 at step 504. The SOS 330 then uses the default values from the default values file to complete the set of preference attribute data at step 506, e.g., by replacing missing values with default values. This step may, optionally, include the computation of a final value based on a default value by replacement of a generic proxy value, as indicated by the dotted block 507. Then, the completed set of preference attribute data can be used, e.g., by the dispatcher 301 and the MMS relay/server 302, to process the received message at step 508. In this exemplary embodiment, the values stored in the database or directory 308 will take precedence over the default values stored in the default configuration file and, if the database entries are complete for a particular request, then no default information need be used to service that request.

For some context, consider application of the exemplary method of FIG. 5 to the processing of an MMS message using the exemplary default values file of FIGS. 4(a)-4(d). Suppose that an MMS message is received by MMC 300 for processing and delivery to a particular recipient. The dispatcher 301 and/or MMS relay/server 302 accesses the database 308 via a plug-in 332 to obtain that recipient's preference data for handling delivery of this MMS message. However, due to provisioning difficulties, other problems, or intentional underprovisioning, the database 308 does not include a field which indicates whether the intended recipient prefers for all MMS messages to be copied to a predetermined email address, e.g., the CPYALLTOEMAIL attribute value associated with this particular user is not present in the database 308. In this case, the SOS 330 will supply the missing value by retrieving the corresponding value from the default values file, e.g., as shown in FIG. 4(a). Therein, the default value for the Boolean field CPYALLTOEMAIL is “false”, which value will be inserted into the values which were obtained from the database 308 and passed on by the SOS 330 to the dispatcher 301 and/or MMS relay/server 302 which requested the data to process the MMS message.

The default values stored in the default values file may, or may not, be final values themselves. Some of the default values stored in the default values file may require further processing to become a final data value for a corresponding one of the preference attributes, e.g., by modifying the default values based upon contextual information which is available to the SOS 330. Consider, for example, the FWDINGEMAIL default attribute illustrated in the fourth line of the exemplary default values file of FIG. 4(b). This exemplary default value is expressed as “[MSISDN]@y.z”, where y.z is an example of the relevant email domain. However the portion of the default value “[MSISDN]” is a generic proxy value which is intended to be replaced by the SOS 330 with the message originator's (or recipient's) actual MSISDN to complete the default value for the FWDINGEMAIL attribute to be passed on as part of the complete set of attribute data. For example, if the subscriber associated with an incoming message has an MSISDN of 18001234567 (which the SOS 330 will know from the context of the message processing request), then the SOS 330 will replace the generic proxy value “[MSISDN]” with “18001234567” before passing along the completed set of attribute data to the MMS relay /server 302 or dispatcher 301.

According to another exemplary embodiment, the use of default information (or the use of database information) can be selective on the part of the MMC 300. For example, a flag can be set which indicates that database requests should be serviced (1) using database values if available and, if not, default values or (2) using only default values. This exemplary embodiment can be used, for example, to test new functionality by populating the default values file without reworking the databases/directories 308. When the flag is set to condition (1), then the SOS 330 can operate as discussed above with respect to FIG. 5. However, when set to condition (2), the SOS 330 will reply to database requests using only default value information from the default value configuration file. This feature can also be used to enable a message processing system wherein a database is not connected to the MMC 300 at all, e.g., for an operator that wishes to initially test MMS service provision without going to the trouble or expense of populating a database.

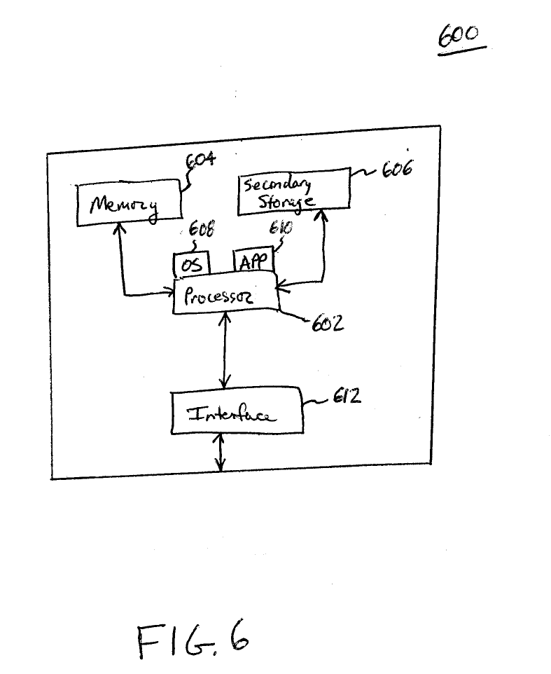

As described above, implementation of messaging methods and services or the like according to these exemplary embodiments can impact messaging nodes in these types of systems. Structurally these nodes can, for example, be implemented in hardware and software as servers or resident on servers which may also serve other functions. For example, as shown generally in FIG. 6, such a server 600 can include a processor 602 (or multiple processor cores), memory 604, one or more secondary storage devices 606, an operating system 608 running on the processor 604 and using the memory 604, as well as a one or more corresponding application(s) 610. An interface unit 612 may be provided to facilitate communications between the node 600 and the rest of the network or may be integrated into the processor 602. Thus, a multimedia messaging center according to an exemplary embodiment can include at least one database for storing subscriber preference attribute data associated with handling of multimedia messages, a multimedia server for receiving a multimedia message and for sending a request for subscriber preference data associated with the multimedia message toward the at least one database, and a plug-in software entity for receiving the request from the multimedia server and selectively providing subscriber preference data in response thereto from at least one of the database and a default values file.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above to provide SOS/plug-in 330/332 functionality. In alternative embodiments, hard-wire circuitry may be used in place of or in combination with software instructions to implement the present invention. Although described above as being co-located with MMS Relay 302 and Dispatcher 301, it will be appreciated that the functionality described above may be located (1) at the communication node requesting data from a database or directory, (2) at the database or directory itself, or (3) at any intervening communication node between the requestor and the database/directory. Moreover, the functionality described above need not all reside in the same location. For example, the mapping mechanism described above can be located at one communication node, while the default values file and filler functionality may reside at a different node.

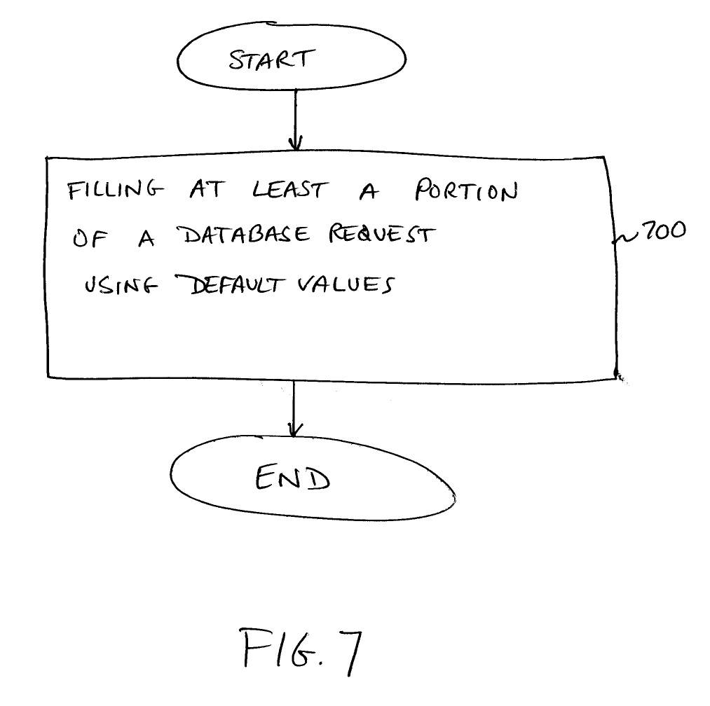

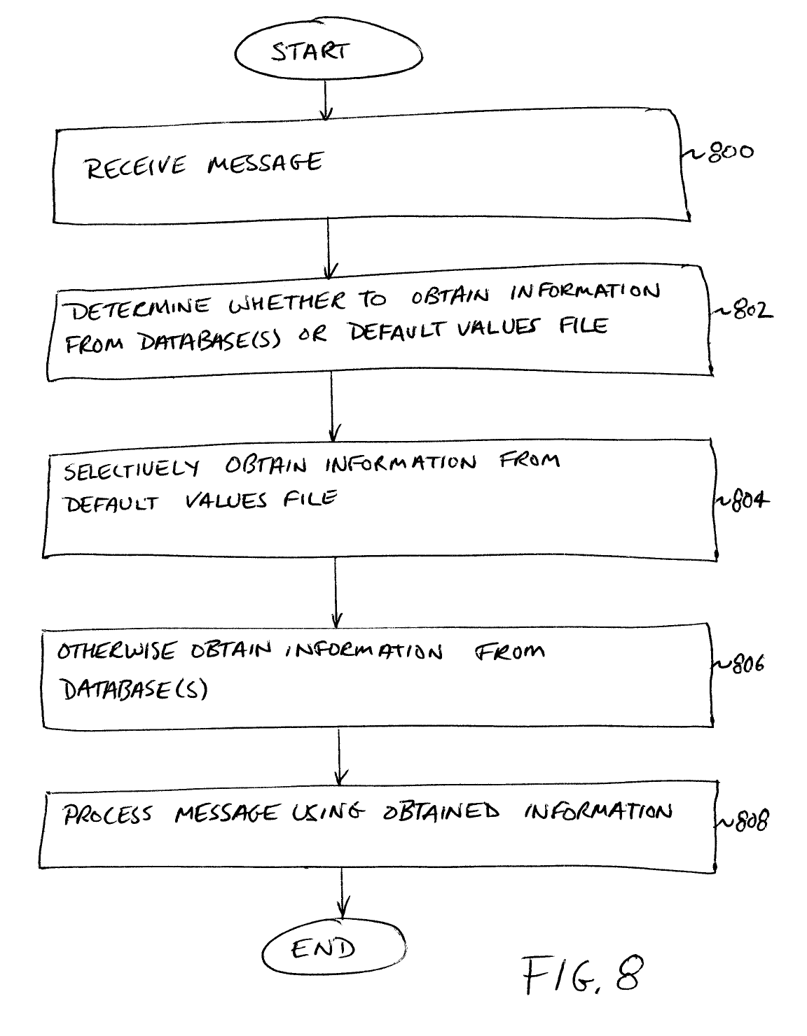

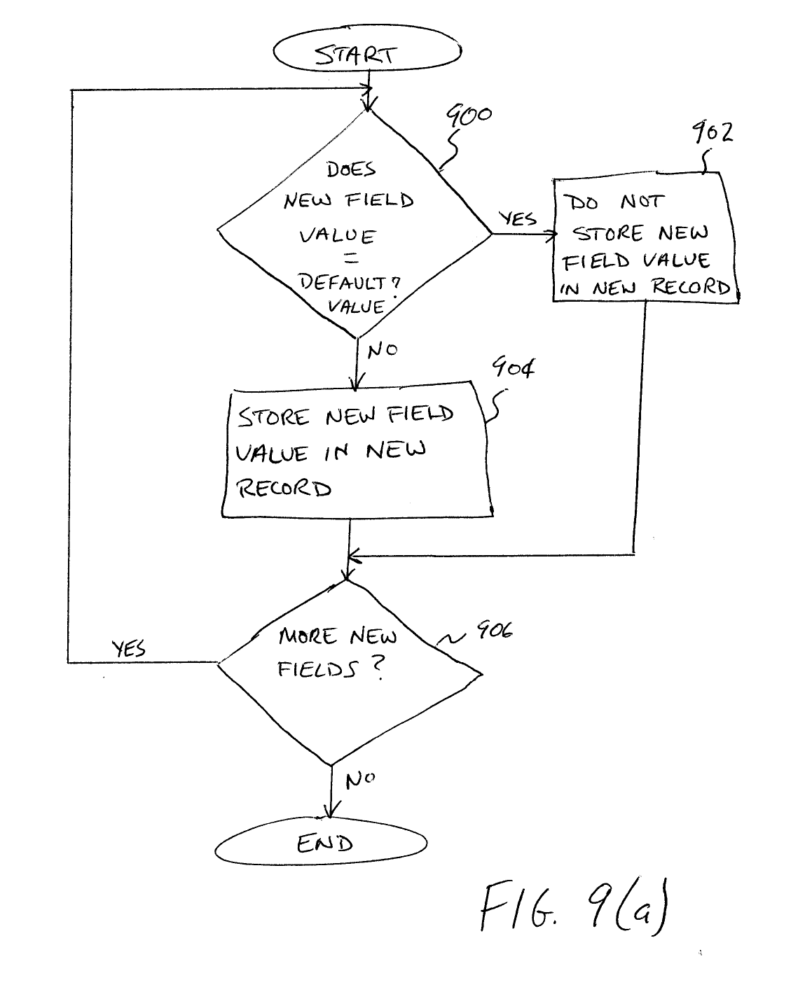

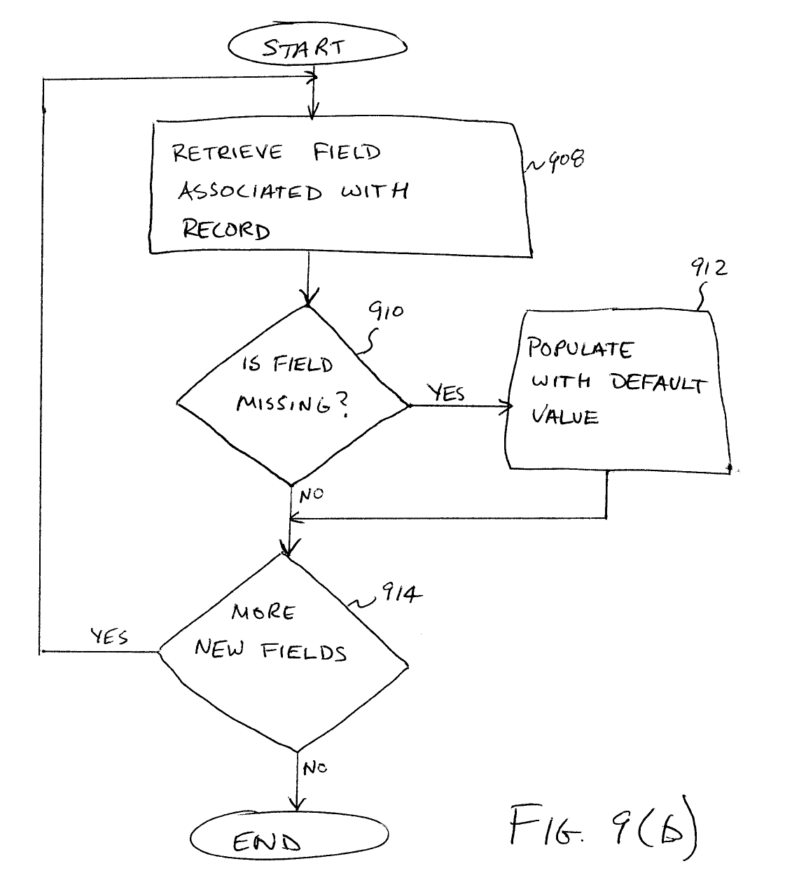

It should be further appreciated that the techniques described herein are not limited to applications which involve messaging, but can be used in conjunction with any types of database requests. Thus, a more general method associated with exemplary embodiments is illustrated in the flowchart of FIG. 7. Therein, a method for handling a database reply to a request for information includes the step 700 of filling at least a portion of a database reply using default values, e.g., retrieved from a file stored within, or outside of, the database.

The availability of default values information can be used in other ways according to these exemplary embodiments. For example, this availability can be used to help, e.g., operators, maintain smaller databases. For example, when a new subscriber is added to a system, a database front-end software can check to see if the attributes associated with the new subscriber, i.e., his or her preferences for message handling, have the same value as the default value for each attribute. Then, only those attribute values which differ from the default values are stored in the database and the subscriber's complete set of attribute data can be retrieved by retrieving the combination of default values and stored values from the database using the technique described above. Consider the following example for this technique. A database that stores personal data (e.g., a government database, a credit card company database, etc.), will usually have a field for a person's gender. This field can be provided with a default value in the default value file of, for example, male. Then, all of the males in the database will have no data for this attribute, which can represent, e.g., about half of the entries for this filed of the database.

Consider another example of this latter technique for a communication system. Suppose that the following four pieces of default attribute data are stored in the default data file.

ALLOWMO:true
ALLOWMT:true
FWDINGEMAIL:default@ericsson.com
MARKETPLAN:EPP_any

Then, an operator creates a new subscriber keyed from his or her phone number of 18001234567 who has attribute values:

ALLOWMO:true
ALLOWMT:true
FWDINGEMAIL:18001234567@phonecie.com
MARKETPLAN:EPP_any

Using the aforedescribed technique, the database 308's record associated with this new subscriber will contain the subscriber ID, 18001234567, with only the attribute FWDINGEMAIL equal to 1800134567@phonecie.com. When the system retrieves this subscriber's preference information, it will obtain one attribute from the database 308 (i.e., FWDINGEMAIL:18001234567@phonecie.com), and the three “missing” attributes from the default values file (i.e., ALLOWMO:true, ALLOWMT:true and MARKETPLAN:EPP_any). Moreover, this technique can be used for all of the attributes and may be particularly useful for fields with highly repetitive values, e.g., country, marital status, etc., to reduce the overall size of the database.

Various other methods for processing messages will be appreciated upon reading of these exemplary embodiments. For example, as shown in the flowchart of FIG. 8, a method for processing messages in a communications system includes the step of receiving a message (step 800) and then determining whether to obtain subscriber preference information associated with the message from at least one database or from a default values file at step 802, e.g., by checking a flag value. Then, the subscriber preference information can selectively be obtained either from the default values file (step 804) or otherwise from the at least one database (step 806). The message can then be processed using the obtained subscriber preference information at step 808.

Another method according to an exemplary embodiment, for storing a new record in a database is illustrated in the flowchart of FIG. 9(a). Therein, at step 900, it is determined, for each field in the new record, whether a value associated with that field is the same as a default value associated with the field. If so, then that value is not stored in the new record (step 902). Otherwise, at step 904, the value is stored in the new record. The process continues until all of the new fields of the new record have been processed by the loop illustrated by block 906. A corresponding, exemplary method for retrieving records which have been stored in accordance with the method of FIG. 9(a) is illustrated in the flowchart of FIG. 9(b). Therein, at step 908, a field of the record is retrieved. If the field is missing (step 910), e.g., because it was intentionally not populated in the database at step 902, then that field is populated with its corresponding default value at step 912. If the field is present in the database, then the flow proceeds to step 914 wherein the loop continues until all fields in the record being retrieved are processed.

MMS, and MMCs according to these exemplary embodiments, support the use of e-mail addresses (RFC 822), MSISDN (E.164) or both to address the recipient of a multimedia message. MMS may support the use of service provider specific addresses to address the recipient of a multimedia message. In the case of e-mail addresses, standard Internet message routing can be used. MSISDN can be used for addressing a recipient in a different MMS service provider's domain via MSISDN translation to a routable address. Thus, MMS message recipient addresses provided within MMS messages received by the MMC 300 may be in a format of an RFC 822 routable address, such as an e-mail address, or other formats, such as E.164 or service provider specific addresses. In those cases where a non-routable address is used to specify a recipient and the recipient belongs to another messaging environment 310, the address can be translated into an RFC 822 routable address format.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. The following claims and their equivalents define the scope of the invention.

1. A method for processing messages in a communications system comprising:
receiving a message;
querying at least one database to obtain data for handling said message;
receiving an incomplete set of data from said at least one database;
completing said set of data using default values; and
processing said message using said completed set of data.

2. The method of claim 1, wherein said data is data associated with preference attributes for handling said message.

3. The method of claim 2, wherein said step of completing said set of preference attribute data further comprises:
computing a final data value associated with one of said preference attributes by modifying one of said default values.

4. The method of claim 3, wherein said default value corresponding to said one of said preference attributes includes a generic proxy value and wherein said step of computing a final value further comprises:
replacing said generic proxy value with another value based upon contextual information.

5. The method of claim 4, wherein said one of said preference attributes is a forwarding email attribute, said default value of said forwarding email attribute is [MSISDN]@emaildomain, said generic proxy value is [MSISDN] and said step of replacing said generic proxy value further comprises the step of:
replacing [MSISDN] with said recipient's mobile station integrated services digital network(MSISDN) number.

6. The method of claim 1, wherein said message is a multimedia services (MMS) message.

7. The method of claim 2, wherein said step of querying said at least one database further comprises:
mapping an expected data schema associated with said preference attributes to an available data schema associated with said preference attributes.

8. A method for processing messages in a communications system comprising:
receiving a message;
determining whether to obtain subscriber preference information associated with said message from at least one database or from a default values file;
selectively either obtaining said subscriber preference information from said default values file;
otherwise, obtaining said subscriber preference information from said at least one database; and
processing said message using said subscriber preference information.

9. The method of claim 8, wherein said if said subscriber preference information is obtained from said at least one database and if said subscriber preference information is incomplete, then:
completing said subscriber preference information using said default values file.

10. The method of claim 9, further comprising:
computing a final data value associated with information obtained from said default values file by modifying a generic proxy value included therein.

11. The method of claim 10, wherein one element of said subscriber preference information is a forwarding email attribute, a default value of said forwarding email attribute is [MSISDN]@emaildomain, said generic proxy value is [MSISDN] and said step of modifying said generic proxy value further comprises the step of:
replacing [MSISDN] with a recipient's mobile station integrated services digital network(MSISDN) number.

12. The method of claim 8, wherein said message is a multimedia services (MMS) message.

13. The method of claim 8, wherein said step of obtaining said subscriber preference information from said at least one database further comprises:
mapping an expected data schema associated with preference attributes to an available data schema associated with said preference attributes.

14. A method for handling a reply to a database request comprising:
filling at least a portion of said reply to said database request using default values.

15. The method of claim 14, wherein said step of filling at least a portion of said reply to said database request further comprises:
filling all of said reply to said database request using said default values.

16. The method of claim 14, further comprising the step of:
checking a flag value to determine whether to fill all of said reply to said database request using said default values or whether to fill only incomplete field values returned from a database with said default values.

17. The method of claim 16, further comprising:
querying, if said flag value indicates that said default values are to be used to fill only incomplete field values, said database; and
mapping an expected data schema associated with queried values to an available data schema associated with said queried values.

18. A method for using a database comprising:
storing a new record in said database by:
determining, for each field in said record, whether a value associated with said field is the same as a default value associated with said field;
if so, then not storing said value in said new record; and
otherwise, storing said value in said new record; and
retrieving said new record from said database by:
retrieving stored fields from said record; and
populating missing fields in said record with default values.

19. A multimedia messaging center comprising:
at least one database for storing subscriber preference attribute data associated with handling of multimedia messages;
a multimedia relay and/or server for receiving a multimedia message and for sending a request for subscriber preference data associated with said multimedia message toward said at least one database; and
a software entity for receiving said request from said multimedia server and selectively providing subscriber preference data in response thereto from at least one of said database and a default values file.

20. A computer-readable medium containing instructions which, when executed on a computer, perform the steps of:
querying at least one database to obtain data associated with preference attributes for handling said message;
receiving an incomplete set of preference attribute data from said at least one database; and
completing said set of preference attribute data using default values.

21. A node for processing messages comprising:
a memory device for storing a default values file; and
a processor for receiving a message and for sending a database query to obtain data for handling said message and for receiving an incomplete set of data in response to said database query,
wherein said processor completes said data for handling said message by retrieving data from said default values file to fill in data which is missing in said incomplete set of data and processes said message using said completed set of data.

22. The node of claim 21, wherein said data is data associated with preference attributes for handling said message.

23. The node of claim 22, wherein said processor completes said set of preference attribute data by computing a final data value associated with one of said preference attributes by modifying one of said default values.

24. The node of claim 23, wherein said default value corresponding to said one of said preference attributes includes a generic proxy value and wherein processor computes said final value by replacing said generic proxy value with another value based upon contextual information.

25. The node of claim 24, wherein said one of said preference attributes is a forwarding email attribute, said default value of said forwarding email attribute is [MSISDN]@emaildomain, said generic proxy value is [MSISDN] and said processor replaces said generic proxy value by replacing [MSISDN] with said recipient's mobile station integrated services digital network(MSISDN) number.

26. The node of claim 21, wherein said message is a multimedia services (MMS) message.

27. The node of claim 22, wherein said processor maps an expected data schema associated with said preference attributes to an available data schema associated with said preference attributes.
